(19) United States
(12) Patent Application Publication
(10) Pub. No.: US 2009/0130965 A1
(43) Pub. Date: May 21, 2009

(54) Climate control system for parked automobiles

(76) Inventor: Antonio Martin Galvez-Ramos, Wellington, FL (US)

Correspondence Address: ANTONIO MARTIN GALVEZ- RAMOS, 15105 Cedar Bluff Place, Wellington, FL, 33414, US

(21) Appl. No.: 11/985,791

(22) Filed: Nov. 17, 2007

(51) Int. Cl. B60H 1/00; B60H 1/22; B60H 1/24; B60L 1/02

(52) U.S. Cl. 454/75; 165/202; 165/41; 219/202; 237/28; 237/5; 454/69

(57) ABSTRACT

The components used in this invention has never been utilized in this special type of arrangement ever before. This “Climate Control for Parked Automobiles” does not exist and cannot be found anywhere.

Once available to the public it will be very helpful and will help stranded passengers and/or pets inside the automobile during warm summer days, and to drivers returning to their warm vehicles during cold winter days.

### BACKGROUND OF THE INVENTION

1.—Field of the Invention

This invention pertains to the field of electrical automobile systems, and is directed to the climate control of parked automobiles.

2.—Description of Previous Similar Work

I have sent myself a previous work (See application Ser. No. 11/351,431 with patent pending) with a title “Air Cooling System for Parked Automobiles”, which address only the rising air temperature inside a parked vehicle, during hot summer days.

The present system goes beyond that, as it also addresses the problem of hot internal air temperatures (besides extremely cold air internal temperatures) of parked automobiles, which they develop during winter time.

The Climate Control System for Parked Automobiles will make a car more comfortable to a returning driver and safer to any stranded passenger left behind such as babies, small children and pets.

### BRIEF SUMMARY OF THE INVENTION

The inside air temperature of parked automobiles can rapidly reach extremely high or low temperatures during the summer and winter time, after the engine and the air conditioner/heater has been shut off.

After only a few minutes, the inside of the vehicle can be so hot or so cold, that the driver will be extremely uncomfortable to even seat inside the automobile.

Both of the above conditions can be drastically mitigated without the need of having to start the automobile's air conditioner or heater, which would require the presence of the driver, to start the vehicle and for the car to be located in a open area to avoid the fumes which can cause harm.

The solution for this problem can be accomplished by using a string of dedicated batteries, that will be provide the energy for a fan blower, which can be used during the summer time to blow the cooler outside air inside the vehicle, or during winter time to run the fan blower plus a heater resistor filament that will heat up the air inside the vehicle to a more comfortable level, without the need of the presence of a driver or even having to start the automobile's engine.

To be able to recharge the string of dedicated batteries, this Climate Control System will incorporate an oversize dynamo which will be able to feed the regular automobile electric load, plus the batteries of this new Climate Control system, through a Charger Controller.

### DESCRIPTION OF THE DRAWINGS

A better understanding of the Climate Control System for Parked Automobiles will be had by reference to the drawing wherein:

FIG. 1 of 1.

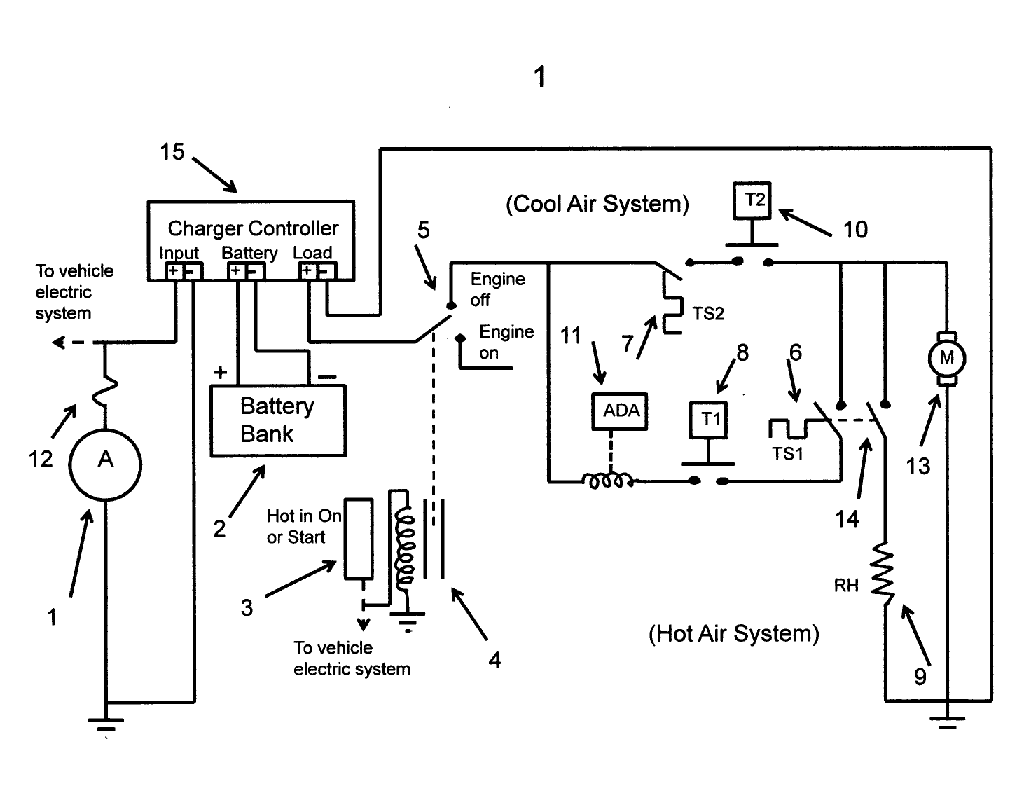

1.—This is the vehicle alternator that has been oversized in order to be able to recharge a dedicated Battery Bank (2). This Alternator should be able to provide at least 30 A more than the original one. A typical oversize alternator for a full size car will be rated for 100 A, 12 VDC.

2.—This is a dedicated Battery Bank for the Climate Control System for Parked Automobiles (CCSPA). It is made of three Gel batteries, high cycling (deep cycle type), that can provide over 3 hours of runtime with a load of 1.2 KW, and does not require any type of maintenance and can be installed in any position and does not releases any substantial amount of gases, because is a sealed type battery.

Gel batteries are normally used in outdoor applications where limited gas emissions are required, such in Cable TV power supplies, and regular cycling is expected such in golf carts and boats. These types of batteries are used to back up loads that require long runtimes.

The car battery is usually a wet type design that basically only works during start. This car battery is not designed to provide long runtimes. By the same token, the Gel Battery it is not designed to start the engine of the automobile, as the high current of the start will eventually destroy the Gel Battery.

Both are sealed and Valve Regulated type.

The batteries for this application will be rated for 12V, with six 2 Volts cells and with a capacity of 108AH.

The typical dimensions are: 12 15/16″ (L); 6¾″ (W), 9⅜″ (H) with 69.5 lbs, and could be easily installed inside the automobile.

3.—This is a contact from the automobile electric system and is hot when the car engine starts or is running.

4.—This is a Relay that connects the battery bank to the CCSPA electric system when the vehicle is turn off.

When the engine is turn on and during the start, the relay will switch from the Engine Off contact to the Engine On position, disabling in this way the Climate Control System for parked Automobiles electrical system.

5.—The switch that operates with the above Relay (4), connecting or disconnecting the CCSPA electric system. It is rated for 120 A, 12 VDC.

6.—Temperature relay (TS1) that is pre-set for cool temperatures that develops during the winter time, and is mechanically interlocked with the Switch (14). This relay could be set to close at temperatures of about and under 25 F.

7.—.—Temperature relay (TS2) that is pre-set for hot temperatures that develops during the summer time. This relay could be set to close at temperatures of about and over 85 F.

8.—Timer button switch “T1”, will close when pushed by the driver and will remain in this position for 30 minutes after the circuit has been closed by Relay TS1 (6).

9.—The Resistor Heater element of about 1 Kw at 12VDC (or similar value), that once energized will provide the heat that will warm up the air inside the car.

10.—Timer button switch “T2”, will close when pushed by the driver and will remain in this position for 60 minutes after the circuit has been closed by Relay TS2 (7).

11.—This is a Relay that is connected to the air ventilation system of the vehicle and once is energized, it will send a signal to the ventilation system (ADA) to close and recirculate the air, so no cold air is drawn from the outside into the inside of the car, because if so, this will slowdown the warm up process of the car's internal air temperature.

12.—This is the fuse of the alternator with will be rated for 130 A (or similar value).

13.—The vehicle Blower Motor. Rated for 12V, 20 Amp, this is a motor that pumps air into the inside of the automobile during A/C activation or just when fresh air is needed (car fan activated).

14.—This Switch rated for 100 A, 12 VDC, will be mechanically interlocked to the Temperature Relay TS1(6), so when this relay closes, the Switch (14) will do the same.

15.—Charger Controller. It will limit the current drawn by the batteries to 30 A (or similar value), so they do not get damaged by excessive current, and will also disconnect the batteries when they reach the low voltage cut off point, protecting in this way, the integrity of these units, which can not be totally depleted.

It will also provide temperature compensation, so the batteries are always properly charged.

### DETAILED DESCRIPTION OF THE INVENTION

This invention has been designed with the purpose of working when the automobile has been parked and the engine has been turn-off in places where the ambient temperature can reach extremes, such as during summer time when the air inside the car rapidly reaches over 70 F after the car has been parked and left by the driver, and there are passengers left inside (or pets), facing lethal high extreme hot air temperatures.

This invention will also work with very low winter temperatures. If the vehicle is parked during the winter time, the inside will get extremely cold after only a few minutes, making it very unpleasant and unsafe for any passengers (or pets) left behind.

Here is who this invention works:

### A.—During Summer Time—Cool Air System

As we do not want to activate this Cool Air System by accident, while the car is being driven (at this time the driver can use the standard A/C system or the automobile forced air ventilation system), THREE conditions need to be met in order to active this system.
The first one is that the car is turn off. As soon as the driver parks the automobile and shut off the engine, the Contact (3) will lose energy and the Relay (4) will be demagnetized, and therefore will move the switch (5) from the Engine On position to the Engine Off position.
The second condition is that the driver before exiting the car pushes a “Timer Button/Switch T2” (10).
The third condition is that the inside of the vehicle reaches the preset temperature of this relay TS2 (7) of 85 F level (or similar value).

Once all this tree conditions have been met, the “Cool Air System” circuit will get activated automatically and therefore will conduct the current to operate the Blower Motor (13) that will be fed by the Battery Bank (2), through the Charger Controller (15).

This will continue until the inside temperature of the car reaches a preset value of 75 F (or similar value) or the preset time of 1 hr (or similar value) has been met. Whichever comes first.

If the driver returns before the internal temperature has dropped below the 75 F threshold or before the 1 Hr preset time, when the driver starts the engine, the Contact (3) will get energized again, and the Relay (4) will activate the Switch (5), making it to change position from “Engine Off” to the “Engine On” position and by doing so, deactivating the circuit of the “Cool Air System”.

### B.—During Winter Time—“Hot Air System”

Here again, we do not want to activate the “Hot Air System” by accident, while the car is being driven (at this time the driver can use the standard heater system of the automobile), therefore THREE conditions need to be met in order to active this system.
The first one is that the car is turn off. As soon as the driver parks the automobile and shut off the engine, the Contact (3) will lose energy and the Relay (4) will be demagnetized, and therefore will move the switch (5) from the Engine On position to the Engine Off position.
The second condition is that the driver before exiting the car pushes a “Timer Button/Switch T1” (8).
The third condition is that the inside of the vehicle reaches the preset temperature of this Relay TS1 (6) of about or under 25 F (or similar value).

Once this temperature is reached and the Relay (6) closes, the Switch (14) will also close, because both are mechanically interlocked.

After all this three conditions have been met, the “Hot Air System” circuit will get activated and the Resistor Heater element RH (9) will start working and increasing its temperature. At this time, the Relay (11) that activates the recirculation mechanism of the vehicle will close, so the cold air front the outside will not get into the vehicle, and Blower Motor (13) will start working and blowing hot air inside the car.

All this system will be fed by the Battery Bank (2) through the Charger Controller (15), which is capable of supplying power to this circuit for over 3 hours if necessary.

This will continue until the inside temperature of the car reaches a preset value of 40 F (or similar value) or the preset time of 30 minutes (or similar value) has been met.

If the driver returns before the internal temperature has increased to the 40 F threshold or before the 30 min. preset time, when the driver starts the engine, the Contact (3) will get energized again, and the Relay (4) will activate the Switch (5), making it to change position from “Engine Off” to the “Engine On” position and by doing so, opening and disconnecting the circuit of the “Hot Air System”.

After the driver returns and starts the automobile, the Alternator (1) through the Charger Controller (15) will start to recharge the battery bank (2) with a current of 30 Amps, and because the batteries where working for a limited time, the Alternator (1)/Charger Controller (15) will be able to recharge the Battery Bank (2) in about 1-2 hrs time. A full charge of a depleted batteries (but still above the cutoff point) will take approximately 8 hrs, but this would be the worst case scenario, if the system is being used constantly without running the automobile.

The three sealed gel batteries (or similar) from the Battery Bank (2) will be connected in parallel, so they can be recharged by a 12VDC charger system.

What I claim is:

1. A new electrical car system design that will be used to warm up or cool down the air inside of a parked motorized vehicle during the absence of the driver, with the help of dedicated batteries and a blower motor during hot days and for the cold winter days with the help of the blower motor, a resistor heater element and the use of dedicated batteries and a battery charger controller.
This system will work automatically once the proper push button has been pressed (for summer or winter), with the purpose of improving the air temperature of the vehicle, so in hot summer days, a pet can be left alone inside the car for a small period of time, without being exposed to lethal temperatures or during the winter time to warm up the air of the parked vehicle so the driver can come back to the car and be able to comfortable seat inside, instead of returning to a frozen vehicle where the steering wheel can not even be touched without the help of gloves.

2. The said electrical system in accordance with claim 1, where different amount of batteries are used.

3. The said electrical system in accordance with claim 1, and/or claim 2, where different type of batteries (Wet type, AGM type, Ni-Cad, etc) are used.

4. The said electrical system in accordance with claim 1, where another source of electrical energy is used instead of batteries, such as fuel cell.

5. The said electrical system in accordance with claim 1, where the electrical power is hooked up externally to the car by means of a battery bank, generator or solar panel.

6. The said electrical system in accordance with claim 1, where a programmable timer is used to better manage the start and duration of the Climate Control System.

7. The said electrical system in accordance with claim 1, where different type of temperature relays/sensors are used.

8. The said electrical system in accordance with claim 1, where the Timer Buttons are replaced or used in combination with external wireless controls, in order to activate the Climate Control System remotely.
